(19) United States
(12) Patent Application Publication
(10) Pub. No.: US 2024/0380161 A1
(43) Pub. Date: Nov. 14, 2024

(54) ELECTRICAL CONNECTOR WITH ERGONOMIC AXIAL MATING ASSIST DEVICE

(71) Applicant: Aptiv Technologies AG, Schaffhausen (CH)

(72) Inventors: Jeffrey S. Campbell, West bloomfield, MI (US); Wesley W. Weber, Lapeer, MI (US); Kurt Seifert, Cortland, OH (US)

(21) Appl. No.: 18/659,149

(22) Filed: May 9, 2024

Related U.S. Application Data
(60) Provisional application No. 63/465,629, filed on May 11, 2023.

(51) Int. Cl. H01R 13/629; H01R 13/502; H01R 13/627

(52) U.S. Cl. CPC H01R 13/62938; H01R 13/502; H01R 13/6272; H01R 13/62955

(57) ABSTRACT

A connector system may include a connector having a connector housing. The connector system may include a cam member rotatably attached to the connector housing. The cam member may define an engaging lug offset from an axis of rotation of the cam member. A connector system may include user moveable member slidably attached to the connector housing. The user moveable member may define a first cam slot inboard having a strap across an entrance portion of the first cam slot in which the engaging lug is received. The engaging lug has a chamfered leading edge that is configured to lift the strap as the engaging lug is inserted into the first cam slot. The user moveable member is configured to rotate the cam member via movement of the engaging lug through the first cam slot. A method of assembling a connector system also presented.

### CROSS-REFERENCE TO RELATED APPLICATIONS

This application claims the benefit of and priority to U.S. Provisional Application 63/465,629, titled “Ergonomic Low Profile Axial Mate Assist Electrical Connector with Manufacturing Assembly Features”, filed May 11, 2023, the contents of which are incorporated by reference herein.

### TECHNICAL FIELD

This disclosure is directed to an electrical connector and in particular to an electrical connector having a mating assist device.

### BACKGROUND

As vehicle electrical content increased, manufacturers desired to reduce the overall number of connection systems per vehicle, this led to a higher number of input/output (I/O) connections per system. Because these connector systems have higher mating forces, hand-mating may not be within ergonomic force limits. Instead, connector systems were often drawn together using bolts or special tools. Over time, bolted connections were replaced by an integral lever mating system for reducing mating forces to an ergonomically acceptable limit. These lever mating systems required pre-positioning the connector prior to closing the lever assist mechanism. Due to the cumbersome nature of this multi-step mating process, these connection systems were not ergonomically friendly and were also prone to improper mating and mating damage.

### SUMMARY

In some aspects, the techniques described herein relate to a connector system, including: a connector having a connector housing; a cam member rotatably attached to the connector housing and having an engaging lug offset from an axis of rotation of the cam member; and a user moveable member slidably attached to the connector housing and having a first cam slot inboard having a strap across an entrance portion of the first cam slot in which the engaging lug is received, the engaging lug having a chamfered leading edge configured to lift the strap as the engaging lug is inserted into the first cam slot, the user moveable member configured to rotate the cam member via movement of the engaging lug through the first cam slot.

In some aspects, the techniques described herein relate to a method of assembling a connector system, including: forming a first connector by rotatably attaching a cam member defining an engaging lug to a connector housing, wherein the engaging lug is offset from an axis of rotation of the cam member and wherein the engaging lug has a ramped lead in surface; slidably attaching a user moveable member defining a first cam slot and having a strap across and an entrance of the first cam slot to the connector housing, wherein the strap is arranged between the first cam slot and an outer edge of the connector housing; and inserting the engaging lug within the first cam slot by flexing and lifting the strap over the engaging lug using the ramped lead in surface of the engaging lug.

### BRIEF DESCRIPTION OF THE DRAWINGS

Embodiments of the present invention will now be described by way of example with reference to the accompanying drawings, in which:

FIG. 1 illustrates an isometric view of an electrical connector according to some embodiments.

FIG. 2 illustrates an exploded view of the electrical connector of FIG. 1 according to some embodiments.

FIG. 3 illustrates an isometric view of a first step of assembling the electrical connector of FIG. 1 according to some embodiments.

FIG. 4 illustrates an isometric view of a second step of assembling the electrical connector of FIG. 1 according to some embodiments.

FIG. 5 illustrates an isometric view of a third step of assembling the electrical connector of FIG. 1 according to some embodiments.

FIG. 6 illustrates an isometric view of a fourth step of assembling the electrical connector of FIG. 1 according to some embodiments.

FIG. 7 illustrates an isometric view of the latching feature of the electrical connector of FIG. 1 in a first position according to some embodiments.

FIG. 8 illustrates an isometric view of a second latching feature of the electrical connector of FIG. 1 in a second position according to some embodiments.

FIG. 9 illustrates an isometric view of a third latching feature of the electrical connector of FIG. 1 in a third position according to some embodiments.

FIG. 10 illustrates view of the electrical connector of FIG. 1 mated with a corresponding electrical connector with a slider of the electrical connector being shown as translucent to allow viewing of a connector housing and cam of the electrical connector beneath the slider according to some embodiments.

FIG. 11 is a flow chart of a method of assembling a connector system according to some embodiments.

### DETAILED DESCRIPTION

According to some aspects, an electrical connector utilizes an axial mating assist device configured to utilize pin and channel features to engage the axial slider with a rotating mate assist cam located on the connector housing. The channel shape may be contoured to optimize the ergonomic force feedback to the assembly operator mating the connector. This arrangement reduces the forward slider travel as compared to previous gear rack driven connector systems and enables the electrical connector to be used with more compact short length device headers, which are desirable for space savings, especially in automotive vehicle packaging. This electrical connector presented herein also includes several other features that provide low part cost and low cost assembly methods.

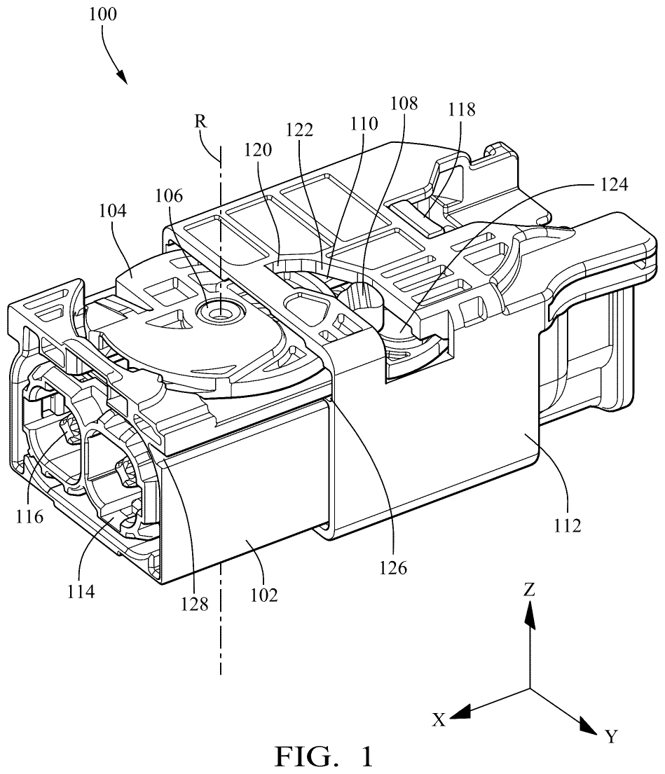

FIG. 1 illustrates a non-limiting example of an electrical connector, hereafter referred to as the connector 100. The connector 100 includes a connector housing 102 and a cam member 104 mounted to a pivot post 106 on the connector housing 102. An engaging lug 108 on the cam member 104 engages a first cam slot 110 in a user moveable member, hereafter referred to as the slider 112 that fits over the connector housing 102 and is configured to slide axially (i.e., along the longitudinal X axis) in relation to the connector housing 102 to rotate the cam member 104 to pull the connector 100 and a corresponding electrical connector 800 (see FIG. 8) together as will be explained in detail below. The connector 100 may also include a primary lock retainer 114 configured to secure electrical terminals 116 within the connector housing 102. The connector 100 may also include a connector position assurance device, hereafter referred to as the CPA device 118. In electrical connector applications that do not require connector position assurance, the CPA device 118 may be omitted.

In some embodiments, the engaging lug 108 is in the form of a post that extends along a vertical axis Z that is substantially parallel to an axis of rotation R of the cam member 104 around the pivot post 106. The slider 112 defines a curved first cam slot 110 in which the engaging lug 108 is received. The first cam slot 110 has a substantially straight entrance portion 120 that is generally parallel to the longitudinal axis X, a curved camming portion 122, and a substantially straight end portion 124 that is generally perpendicular to the longitudinal axis X. In some embodiments, the slider 112 defines rails 126 that are received within slots 128 in the connector housing 102. The rails 126 and the slots 128 are configured to cooperate with one another to cause the slider 112 to move relative to the connector housing 102 in a substantially straight path along the X axis. The cam member 104 is rotated by movement of the engaging lug 108 through the first cam slot 110 as the slider 112 is moved longitudinally relative to the connector housing 102.

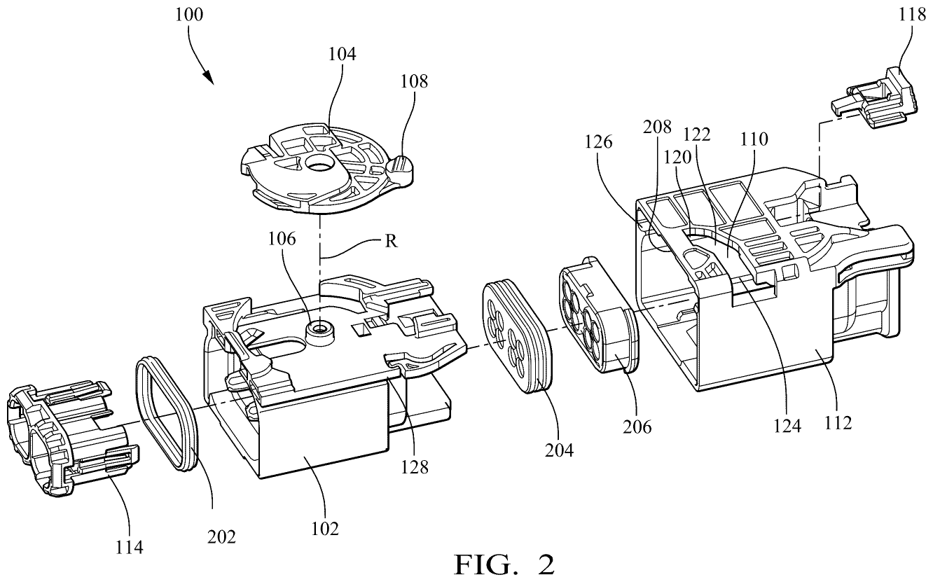

As shown in the exploded view of FIG. 2, the connector 100 further includes a connector housing seal 202 within the connector housing 102 and a mat seal 204 configured to provide a seal for electrical cables (not shown) attached to the electrical terminals 116 and a strain relief device 206 configured to provide strain relief for the cables as well as retain the mat seal 204 within the connector housing 102. In electrical connector applications that do not require protection from environmental contaminants, such as water and/or dust, the connector housing seal 202 and the mat seal 204 may be omitted.

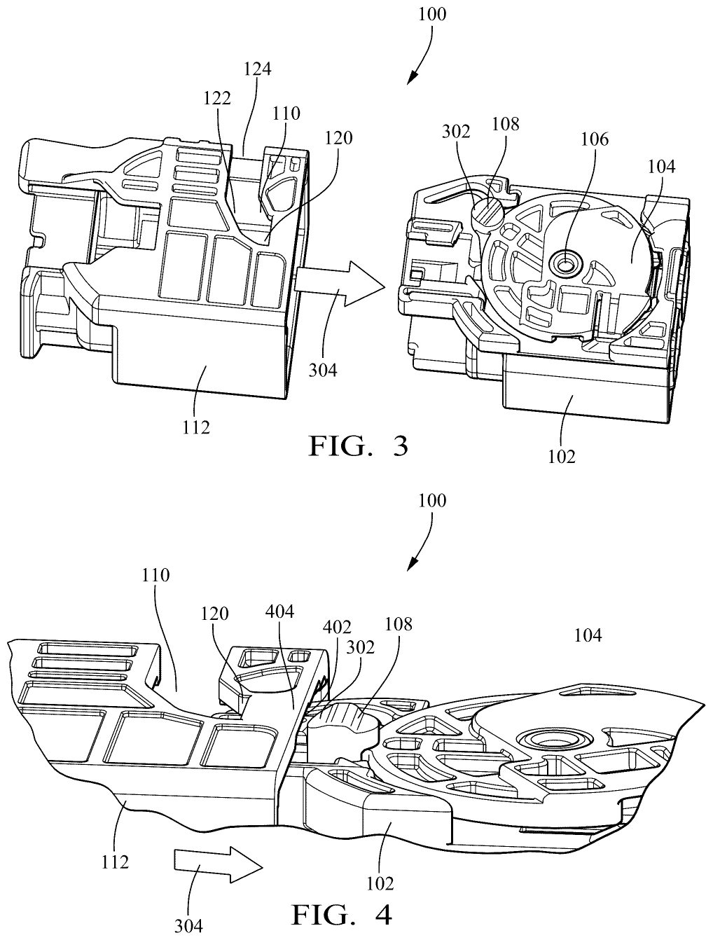

FIG. 3 shows a first step of a process of assembling the connector 100 in which the connector housing 102 is received within the slider 112 as slider 112 is moved axially in a direction indicated by arrow 304. The engaging lug 108 has a ramped lead in surface 302.

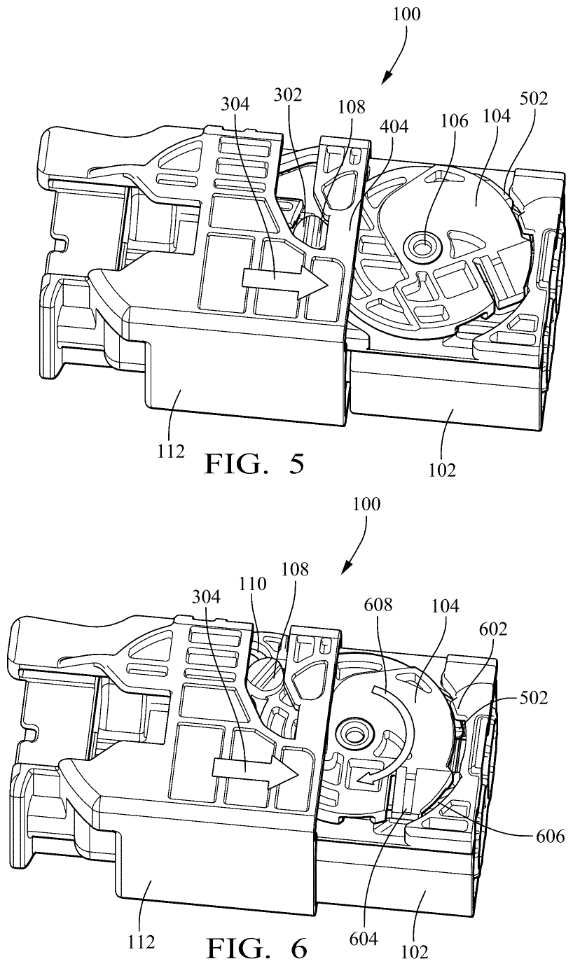

FIG. 4 shows a second step of the process of assembling the connector 100 in which the slider 112 continues to move in an axial direction indicated by arrow 304 to the connector housing 102 and the engaging lug 108 is aligned with and inserted into the entrance portion 208 of the first cam slot 110. In some embodiments, the ramped lead in surface 302 contacts a chamfered leading edge 402 of a strap 404. The ramped lead in surface 302 pushes or deforms the strap 404 upwardly, thereby allowing the engaging lug 108 to enter the first cam slot 110 in the slider 112. The strap 404 of the slider 112 then returns to its original shape and secures the engaging lug 108 within the first cam slot 110 as shown in FIG. 5. The strap 404 generally increases the rigidity off the slider 112.

FIG. 5 also shows a cam retention feature 502 on the back side of the cam member 104. At this stage of assembly, the engaging lug 108 is located within the first cam slot 110 but axial movement of the slider 112 relative to the housing 102 along the direction indicated by arrow 304 and corresponding movement of the engaging lug 108 within the first cam slot 110 has not caused the cam member 104 to begin rotating. As shown in FIG. 5, the cam retention feature 502 is not engaged with a housing hold down feature 602. As the engaging lug 108 continues along the path defined by the first cam slot 110, the rotation of the cam member 104 causes the cam retention feature 502 to engage the housing hold down feature 602.

As shown in FIG. 6, continued axial movement of the slider 112 relative to the connector housing 102 causes the engaging lug 108 to follow the path defined by the first cam slot 110, which in turn causes the rotation of the cam member 104 as illustrated by arrow 608. As a result, the cam retention feature 502 engages a housing hold down feature 602 on the connector housing 102 as the cam member 104 rotates. A cam flexible stop feature 604 on the cam member 104 rotates to a housing stop feature 606 on the connector housing 102. The cam flexible stop feature 604 is configured to prevent the movement of the cam member 104 and the slider 112 until a rib feature 802 extending from the corresponding electrical connector 800 (see FIG. 8) disengages the cam flexible stop feature 604 as the corresponding electrical connector 800 is mated with the connector 100. In this position, the connector housing 102 and cam member 104 are in a pre-staged condition and ready to receive the corresponding electrical connector 800.

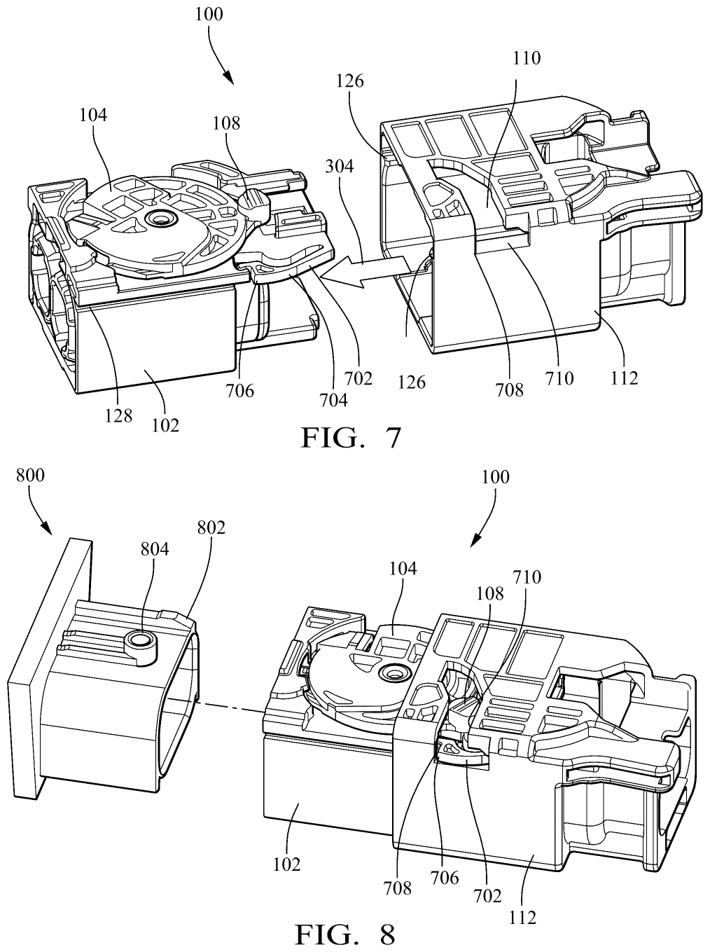

FIG. 7 illustrates a flexible thumb latch 702 defined by the connector housing 102 that has a flexible arm 704 and a latch 706 on the free end of the arm. The flexible thumb latch 702 is configured to secure the slider 112 to the connector housing 102.

As shown in FIG. 8, the latch 706 of the flexible arm 704 engages a first edge 708 of a first opening 710 in the slider 112 to secure the cam member 104 in a position to receive a cam lug 804 of the corresponding electrical connector 800. As further shown in FIG. 8, the rib feature 802 on the corresponding electrical connector 800 is designed to engage with the cam flexible stop feature 604 (shown in FIG. 6) and automatically releases the cam flexible stop feature 604 from the housing stop feature 606 when the connector 100 is mated with the corresponding electrical connector 800. That is, the rib feature 802 deflects the cam flexible stop feature 604 in the vertical (Z) direction, allowing the cam member 104 to continue to rotate in the direction indicated by arrow 608 (shown in FIG. 6).

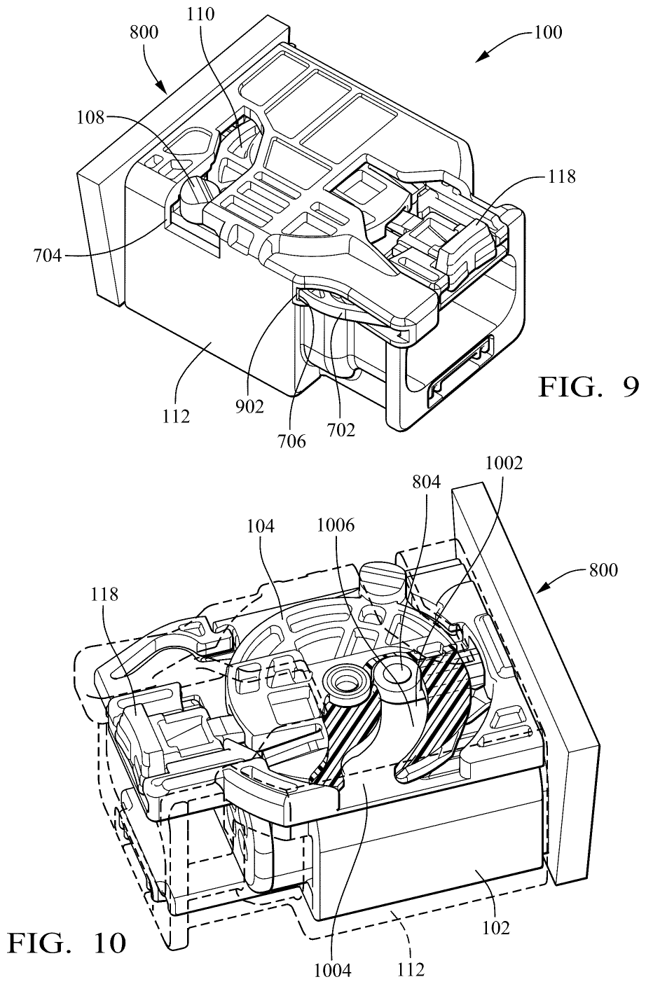

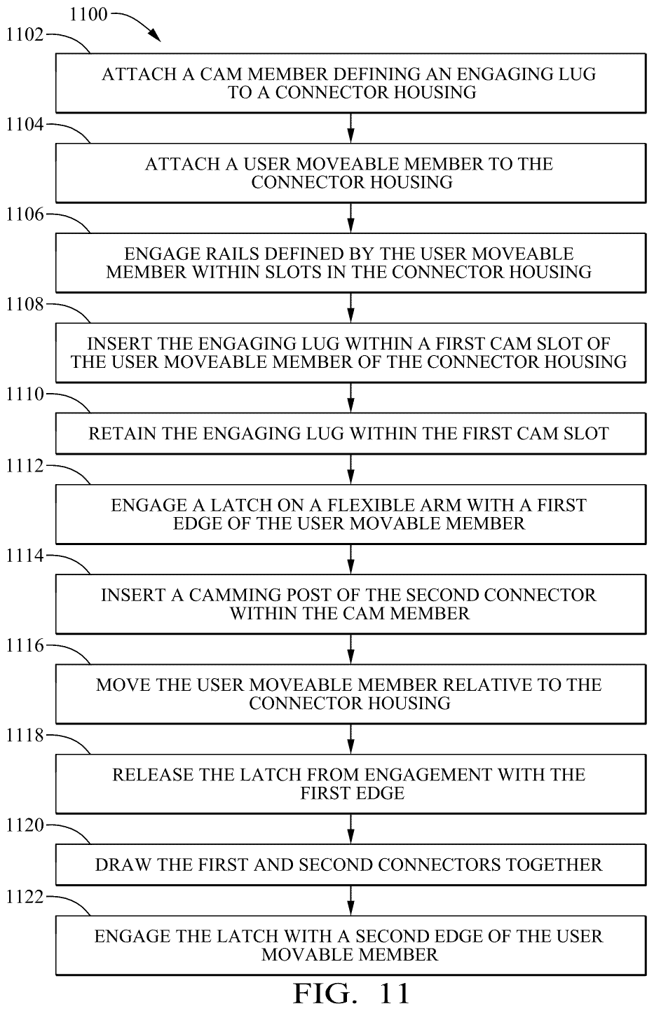

FIGS. 9 and 10 show the connector 100 in a fully staged and mated condition and locked to the corresponding electrical connector 800. As shown in FIG. 9, the flexible thumb latch 702 engages a second edge 902 of a second opening 904 in the slider 112 to secure the connector 100 in a mated condition with the corresponding electrical connector 800.

As shown in FIG. 10, the corresponding electrical connector 800 defines a camming post 804. The camming post 804 is received within a curved second cam slot 806 in the underside of the cam member 104. The second cam slot 806 has a substantially straight entrance portion 808 and a curved camming portion 810. As the cam member 104 is rotated by moving the slider 112 forward on the connector housing 102, the camming post 804 moves along the curved camming portion 810 in the second cam slot 806, thereby mating the connector 100 and the corresponding electrical connector 800 together. Once mated, mating the connector 100 and the corresponding electrical connector 800 may be unmated by rotating the cam member 104 in the opposite direction by moving the slider 112 rearward on the connector housing 102.

The CPA device 118 engages the cam member 104, thereby inhibiting rotation of the cam member 104. The flexible thumb latch 702 engages the connector housing 102 and also engages the cam member 104, thereby further inhibiting rotation of the cam member 104.

FIG. 11 shows a flow chart of a method 1100 of assembling a connector system including the following steps:

At STEP 1102, a cam member defining an engaging lug is attached to a connector housing. In some embodiments, this step includes forming a connector 100 by rotatably attaching a cam member 104 defining an engaging lug 108 to a connector housing 102. The engaging lug 108 is offset from an axis of rotation X of the cam member 104. In some embodiments, the engaging lug 108 has a ramped lead in surface 302.

At STEP 1104, a user moveable member is attached to the connector housing. In some embodiments, this step includes slidably attaching a user moveable member or slider 112 defining a first cam slot 110 and having a strap 404 across and an entrance of the first cam slot 110 to the connector housing 102, wherein the strap 404 is arranged between the first cam slot 110 and the chamfered leading edge 402 of the connector housing 102.

At STEP 1106, rails defined by the user moveable member are engaged within slots in the connector housing. In some embodiments, this step includes engaging rails defined by the slider 112 within slots in the connector housing 102 which are configured to cooperate to cause the slider 112 and the connector housing 102 to slide relative to each other in a substantially straight path.

At STEP 1108, the engaging lug is inserted within a first cam slot of the user moveable member of the connector housing. In some embodiments, this step includes inserting the engaging lug 108 within the first cam slot 110 by flexing and lifting the strap 404 over the engaging lug 108 using the ramped lead in surface 302 of the engaging lug 108.

At STEP 1110, the engaging lug is retained within the first cam slot. In some embodiments, this step includes retaining the engaging lug 108 within the first cam slot 110 by returning the strap 404 to its original unflexed condition.

At STEP 1112, a latch on a flexible arm is engaged with a first edge of the user movable member. In some embodiments, the connector housing 102 defines a flexible arm having a latch and the slider 112 defines a first opening 710 having a first edge 708. The method may further include engaging the latch with the first edge. Engagement of the latch with the first edge configures the connector 100 to be in condition to receive a corresponding electrical connector 800.

At STEP 1114, a camming post of the second connector is inserted within the cam member. in some embodiments, this step includes inserting a camming post of the second connector within the cam member.

At STEP 1116, the user moveable member is moved relative to the connector housing. In some embodiments, this step includes moving the slider 112 relative to the connector housing 102, thereby rotating the cam member 104 by moving the engaging lug 108 along the first cam slot 110.

At STEP 1118, the latch is released from engagement with the first edge. In some embodiments, this step includes releasing the latch from engagement with the first edge.

At STEP 1120, the first and second connectors are drawn together. In some embodiments, this step includes drawing mating the connector 100 and the corresponding electrical connector 800 together by movement of a camming post of the corresponding electrical connector 800 along a second cam slot defined by the cam member 104 due to the rotation of the cam member 104.

AT STEP 1122, the latch is engaged with a second edge of the user movable member. In some embodiments, this step includes engaging the latch with a second edge 902 of a second opening 904 defined by the slider 112 when the slider 112 is moved relative to the connector housing 102, thereby maintaining the connector 100 in a mated condition with the corresponding electrical connector 800.

### Discussion of Possible Embodiments

The following are non-exclusive descriptions of possible embodiments of the present invention.

In some aspects, the techniques described herein relate to a connector system, including: a connector having a connector housing; a cam member rotatably attached to the connector housing and having an engaging lug offset from an axis of rotation of the cam member; and a user moveable member slidably attached to the connector housing and having a first cam slot inboard having a strap across an entrance portion of the first cam slot in which the engaging lug is received, the engaging lug having a chamfered leading edge configured to lift the strap as the engaging lug is inserted into the first cam slot, the user moveable member configured to rotate the cam member via movement of the engaging lug through the first cam slot.

The connector system of the preceding paragraph can optionally include, additionally and/or alternatively any, one or more of the following features, configurations and/or additional components.

In some aspects, the techniques described herein relate to a connector system, wherein the entrance portion of the first cam slot is substantially straight and configured to receive the engaging lug, the first cam slot further including a substantially straight end portion arranged substantially perpendicularly to the entrance portion and a curved camming portion having one or more radii located between the entrance portion and the end portion.

In some aspects, the techniques described herein relate to a connector system, further including a means for retaining the user moveable member in a fixed position relative to the connector housing.

In some aspects, the techniques described herein relate to a connector system, wherein the means for retaining the user moveable member includes a flexible arm having a latch defined by the connector housing which is configured to engage a first edge of a first opening defined by the user moveable member.

In some aspects, the techniques described herein relate to a connector system, wherein the latch has a rounded tip configured to push the flexible arm inwardly due to contact with an interior surface of the connector housing.

In some aspects, the techniques described herein relate to a connector system, wherein the latch is further configured to engage a second edge of a second opening defined by the user moveable member when the user moveable member is moved relative to the connector housing.

In some aspects, the techniques described herein relate to a connector system, wherein the connector is a first connector, wherein the connector system further includes a second connector configured to mate with the first connector and wherein engagement of the latch with the first edge configures the connector to be in condition to receive the second connector

In some aspects, the techniques described herein relate to a connector system, wherein engagement of the latch with the second edge maintains the first connector in a mated condition with the second connector.

In some aspects, the techniques described herein relate to a connector system, wherein a rearward surface of the latch engages the first edge or the second edge.

In some aspects, the techniques described herein relate to a connector system, wherein the connector is a first connector, wherein the connector system further includes a second connector configured to mate with the first connector, and wherein the cam member has a second cam slot configured to contact a camming post of the second connector and draw the first and second connectors together due to rotation of the cam member.

In some aspects, the techniques described herein relate to a connector system, wherein the first connector further includes electrical terminals disposed within cavities defined by the connector housing and wherein the second connector further includes mating electrical terminals.

In some aspects, the techniques described herein relate to a method of assembling a connector system, including: forming a first connector by rotatably attaching a cam member defining an engaging lug to a connector housing, wherein the engaging lug is offset from an axis of rotation of the cam member and wherein the engaging lug has a ramped lead in surface; slidably attaching a user moveable member defining a first cam slot and having a strap across and an entrance of the first cam slot to the connector housing, wherein the strap is arranged between the first cam slot and an outer edge of the connector housing; and inserting the engaging lug within the first cam slot by flexing and lifting the strap over the engaging lug using the ramped lead in surface of the engaging lug.

The method of the preceding paragraph can optionally include, additionally and/or alternatively any, one or more of the following features, configurations and/or additional components.

In some aspects, the techniques described herein relate to a method, wherein the method further includes retaining the engaging lug within the first cam slot by returning the strap to its original unflexed condition.

In some aspects, the techniques described herein relate to a method, wherein the connector housing defines a flexible arm having a latch and the user moveable member defines a first opening having a first edge and wherein the method further includes engaging the latch with the first edge, wherein engagement of the latch with the first edge configures the first connector to be in condition to receive a second connector.

In some aspects, the techniques described herein relate to a method, wherein the method further includes: inserting a camming post of the second connector within the cam member; moving the user moveable member relative to the connector housing, thereby rotating the cam member by moving the engaging lug along the first cam slot; releasing the latch from engagement with the first edge; drawing the first and second connectors together by movement of a camming post of the second connector along a second cam slot defined by the cam member due to the rotation of the cam member; and engaging the latch with a second edge of a second opening defined by the user moveable member when the user moveable member is moved relative to the connector housing, thereby maintaining the first connector in a mated condition with the second connector.

In some aspects, the techniques described herein relate to a method, wherein the latch has a rounded tip configured to push the flexible arm inwardly due to contact with an interior surface of the connector housing.

In some aspects, the techniques described herein relate to a method, wherein a rearward surface of the latch engages the edge of an opening in the connector housing when the first connector is fully mated with the second connector.

In some aspects, the techniques described herein relate to a method, wherein the method further includes engaging rails defined by the user moveable member within slots in the connector housing which are configured to cooperate to cause the user moveable member and the connector housing to slide relative to each other in a substantially straight path.

In some aspects, the techniques described herein relate to a method, wherein the first connector further includes electrical terminals disposed within cavities defined by the connector housing.

While the invention has been described with reference to an exemplary embodiment(s), it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the disclosed embodiment(s), but that the invention will include all embodiments falling within the scope of the appended claims.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

1. A connector system, comprising:
a connector having a connector housing;
a cam member rotatably attached to the connector housing and having an engaging lug offset from an axis of rotation of the cam member; and
a user moveable member slidably attached to the connector housing and having a first cam slot inboard having a strap across an entrance portion of the first cam slot in which the engaging lug is received, the engaging lug having a chamfered leading edge configured to lift the strap as the engaging lug is inserted into the first cam slot, the user moveable member configured to rotate the cam member via movement of the engaging lug through the first cam slot.

2. The connector system according to claim 1, wherein the entrance portion of the first cam slot is substantially straight and configured to receive the engaging lug, the first cam slot further including a substantially straight end portion arranged substantially perpendicularly to the entrance portion and a curved camming portion having one or more radii located between the entrance portion and the end portion.

3. The connector system according to claim 1, further comprising a means for retaining the user moveable member in a fixed position relative to the connector housing.

4. The connector system according to claim 3, wherein the means for retaining the user moveable member comprises a flexible arm having a latch defined by the connector housing which is configured to engage a first edge of a first opening defined by the user moveable member.

5. The connector system according to claim 4, wherein the latch has a rounded tip configured to push the flexible arm inwardly due to contact with an interior surface of the connector housing.

6. The connector system according to claim 4, wherein the latch is further configured to engage a second edge of a second opening defined by the user moveable member when the user moveable member is moved relative to the connector housing.

7. The connector system according to claim 6, wherein the connector is a first connector, wherein the connector system further comprises a second connector configured to mate with the first connector and wherein engagement of the latch with the first edge configures the first connector to be in condition to receive the second connector.

8. The connector system according to claim 7, wherein engagement of the latch with the second edge maintains the first connector in a mated condition with the second connector.

9. The connector system according to claim 6, wherein a rearward surface of the latch engages the first edge or the second edge.

10. The connector system according to claim 1, wherein the connector is a first connector, wherein the connector system further comprises a second connector configured to mate with the first connector, and wherein the cam member has a second cam slot configured to contact a camming post of the second connector and draw the first and second connectors together due to rotation of the cam member.

11. The connector system according to claim 10, wherein the first connector further comprises electrical terminals disposed within cavities defined by the connector housing and wherein the second connector further comprises mating electrical terminals.

12. A method of assembling a connector system, comprising:
forming a first connector by rotatably attaching a cam member defining an engaging lug to a connector housing, the engaging lug being offset from an axis of rotation of the cam member and the engaging lug having a ramped lead in surface;
slidably attaching a user moveable member defining a first cam slot and having a strap across and an entrance of the first cam slot to the connector housing, the strap being arranged between the first cam slot and an outer edge of the connector housing; and
inserting the engaging lug within the first cam slot by flexing and lifting the strap over the engaging lug using the ramped lead in surface of the engaging lug.

13. The method according to claim 12, wherein the method further comprises retaining the engaging lug within the first cam slot by returning the strap to its original unflexed condition.

14. The method according to claim 12, wherein the connector housing defines a flexible arm having a latch and the user moveable member defines a first opening having a first edge and wherein the method further comprises engaging the latch with the first edge, wherein engagement of the latch with the first edge configures the first connector to be in condition to receive a second connector.

15. The method according to claim 14, wherein the method further comprises:
inserting a camming post of the second connector within the cam member;
moving the user moveable member relative to the connector housing, thereby rotating the cam member by moving the engaging lug along the first cam slot;
releasing the latch from engagement with the first edge;
drawing the first and second connectors together by movement of a camming post of the second connector along a second cam slot defined by the cam member due to the rotation of the cam member; and
engaging the latch with a second edge of a second opening defined by the user moveable member when the user moveable member is moved relative to the connector housing, thereby maintaining the first connector in a mated condition with the second connector.

16. The method according to claim 14, wherein the latch has a rounded tip configured to push the flexible arm inwardly due to contact with an interior surface of the connector housing.

17. The method according to claim 14, wherein a rearward surface of the latch engages the edge of an opening in the connector housing when the first connector is fully mated with the second connector.

18. The method according to claim 12, wherein the method further comprises engaging rails defined by the user moveable member within slots in the connector housing which are configured to cooperate to cause the user moveable member and the connector housing to slide relative to each other in a substantially straight path.

19. The method according to claim 12, wherein the first connector further comprises electrical terminals disposed within cavities defined by the connector housing.
